(19) United States
(12) Patent Application Publication
(10) Pub. No.: US 2006/0071578 A1
(43) Pub. Date: Apr. 6, 2006

(54) Micromechanical element having adjustable resonant frequency

(76) Inventors: Christian Drabe, Dresden (DE); Alexander Wolter, Dresden (DE); Harald Schenk, Dresden (DE)

Correspondence Address: GARDNER GROFF SANTOS & GREENWALD, P.C., 2018 POWERS FERRY ROAD, SUITE 800, ATLANTA, GA, 30339, US

(21) Appl. No.: 11/249,060

(22) Filed: Oct. 12, 2005

Related U.S. Application Data
(63) Continuation of application No. PCT/EP03/03943, filed on Apr. 15, 2003.

(51) Int. Cl. H02K 33/00; H02N 1/00

(52) U.S. Cl. 310/309; 310/36; 73/514.32

(57) ABSTRACT

A micromechanical element described includes a vibrating system having a vibrating body and an elastic suspension by means of which the vibrating body is suspended to be able to vibrate, and an adjuster for adjusting a resonant frequency of the vibrating system by applying a voltage difference between at least one part of the vibrating body and at least one stationary electrode.

### CROSS-REFERENCE TO RELATED APPLICATION

This application is a continuation of copending International Application No. PCT/EP03/03943, filed Apr. 15, 2003, which designated the United States and was not published in English, and is incorporated herein by reference in its entirety.

### BACKGROUND OF THE INVENTION

1. Field of the Invention

The present invention relates to micromechanical elements having a vibrating system and, in particular, to adjusting the vibrational frequency of the vibrating system.

2. Description of the Related Art

Micromechanical elements having vibrating systems are employed both in micromechanical sensor and in micromechanical actuators. The vibrating system including a vibrating body and an elastic suspension comprises a natural or resonant frequency. In many applications, the resonant frequency of the vibrating system must correspond to a fixed predetermined frequency in order to achieve, using the resonance increase, for example, sufficient sensitivity in the case of a sensor and a sufficient vibrating amplitude in the case of an actuator. Examples of such micromechanical elements having a vibrating system are clock generators in clocks or deflecting mirrors, such as, for example, scanner mirrors, used for data projection. In the latter scanner mirrors, the data frequency or modulation frequency and the vibrational frequency, for example, must be in a fixed predetermined relation. Another example of an application where a set frequency is predetermined is when a pair of a sensor and an actuator which, in principle, have the same setup are to be synchronized.

In order to keep the power to be provided for generating a vibration small, the vibrating systems of such elements generally comprise a relatively high quality, with the consequence that the resonance curve is narrow and that there is a very small margin in the excitation frequency when maintaining the vibration amplitude desired.

The causes for a deviation of the resonant frequency of the vibrating system of a micromechanical element from a set resonant frequency are manifold and can roughly be divided into two groups, namely those resulting in a constant resonant frequency deviation or resonant frequency offset despite identical and constant environmental conditions and being caused by, for example, production or manufacturing variations/tolerances, and those being subjected to temporal changes and/or being caused by, for example, environmental condition variations. Subsequently, the term “resonant frequency deviation” is used for the constant deviation, for example, caused by manufacturing, of the actual resonant frequency of a micromechanical element from its set resonant frequency, whereas the term “resonant frequency variation” is used for frequency deviations subjected to temporal changes during operation or lifetime.

Consequently, non-matching of the resonant frequency of elements principally having the same setup, which occurs despite identical and constant environmental conditions, for example, falls under the term resonant frequency deviation. The cause for this are variations of frequency-determining material parameters, such as, for example, elastic constants, density, etc., and statistical or systematic deviations of the dimensions of spring and mass or inter-spaces having an attenuating effect due to tolerances in adjusting, structuring and layer generation when manufacturing the micromechanical elements.

The variation of the resonant frequency of the vibrating system of a micromechanical element due to, for example, environmental condition variations, such as, for example, variations of pressure or temperature, falls under the term resonant frequency variation. Resonant frequency variations may, however, also be caused by a differently strong adsorption of different gas molecules, humidity and similar things at the vibrating system or by temporal changes of the material parameters.

The measures known so far for adjusting the resonant frequency of the vibrating system of a micromechanical element to a set resonant frequency may also be divided into two strategy types, namely one strategy according to which, quasi as one of the last manufacturing steps, non-reversible changes may be performed to the micromechanical elements for adjusting the resonant frequency of the vibrating systems, and one strategy according to which the resonant frequency of the vibrating system is corrected to the set resonant frequency during operation, such as, for example, re-adjusted via a control loop. The first strategy is obviously only suitable for compensating permanent resonant frequency deviations and cannot substitute a resonant frequency correction during operation in some applications requiring compensation of resonant frequency variations.

An example of proceedings for adjusting the resonant frequency according to the first strategy is, for example, described in the doctoral thesis by G. K. Fedder with the title “Simulation of microelectromechanical systems”, 1994, in particular in chapter 2.7 on pages 59-66. A tunable micro-resonator is described there in which the resonant frequency of a vibrating body suspended via bending beams can be made adjustable by at first fixing the bending beams by ribs at several fixation points along the length of the bending beams to be cut apart one after the other subsequently after manufacturing to increase the effective length of the bending beams step by step and thus to decrease the spring constant or resonant frequency until a set resonant frequency is obtained. The tuning is obviously, as has already been mentioned, not suitable for correcting resonant frequency variations during operation. Additionally, tuning is irreversible and only possible in the direction to lower resonant frequencies.

There are different approaches for regulating resonant frequency during operation. In U.S. Pat. No. 6,331,909 and U.S. Pat. No. 6,285,489, a resonant frequency regulation is described where ambient pressure is varied to change the resonant frequency, which is how the effective mass of the element moved or vibrating body is changed by means of gas motion and thus also the resonant frequency of the spring-mass system is changed. The apparatuses and the control circuit required for this, however, are relatively complicated. Additionally, an embodiment is described where the spring of the spring-mass system is covered by a gas-absorbing material, changing the material features and thus the frequency when absorbing. Here, too, the relatively high complexity is a disadvantage. Additionally, it must be assumed that the quality of the system is reduced or is not optimal due to the limitation of the selection of materials available for the spring to those of the gas-absorbing type.

U.S. Pat. No. 6,256,131 and U.S. Pat. No. 6,285,489 describe a torsional vibrating system where a part of the rotating mass may be shifted away from the torsion axis or towards the torsion axis by means of electrostatic forces. Here, the moment of inertia and thus again the resonant frequency change. This procedure allows regulating the resonant frequency, greater deviations, however, cannot be corrected due to the generally small translation paths of the movable mass.

### SUMMARY OF THE INVENTION

It is an object of the present invention to provide a concept for adjusting a resonant frequency of a micromechanical element, which may be performed during operation of the micromechanical element and is less complicated.

In accordance with a first aspect, the present invention provides an inventive micromechanical element including an vibrating system having a vibrating body and an elastic suspension by means of which the vibrating body is suspended to be able to vibrate or oscillate, and means for adjusting a resonant frequency of the vibrating system by applying a voltage difference between at least one part of the vibrating body and at least one stationary electrode.

In accordance with a second aspect, the present invention provides an inventive method for operating a micromechanical element having a vibrating system having a vibrating body and an elastic suspension by means of which the vibrating body is suspended to be able to vibrate, including adjusting a resonant frequency of the vibrating system by applying a voltage difference between at least one part of the vibrating body and at least one stationary electrode.

The present invention is based on the finding that a virtual change of the spring constant of the elastic suspension can be achieved by applying a voltage difference between at least one part of the vibrating body on the one hand and one or several stationary electrodes with a suitable arrangement of the one or several stationary electrodes on the other hand, the virtual change in turn providing a change or adjustability of the vibrating system or spring-mass system. Adjusting may be varied infinitely. Additionally, the only things which must be added to the mechanical vibrating system are electrical structures as they may be manufactured without problems and cheaply by means of micromechanical manufacturing methods and as must be provided anyway when exciting the vibrating system electrostatically.

Means for irreversibly correcting permanent resonant frequency deviations is provided in a micromechanical element according to a special embodiment of the present invention apart from the adjustability of the resonant frequency of the vibrating system by applying a voltage difference between the vibrating body and the stationary electrode or stationary electrodes. The result is a combined ability of pre-adjusting and regulating to be able to compensate both resonant frequency deviations and variations. The yield in manufacturing is increased significantly by this since micromechanical elements which, directly after manufacturing, have a resonant frequency outside the frequency range which may be compensated by applying the voltage difference need not be discarded but can be manipulated by the irreversible pre-compensation such that the resonant frequency thereof is sufficiently close to the set resonant frequency. On the other hand, the irreversible pre-adjustability provides the possibility of using micromechanical elements which are manufactured in the same way, for related applications which only differ by the desired resonant frequency, which is how the manufacturing costs can again be reduced.

According to a special embodiment of the present invention, a micromechanical element includes an element frame and a vibrating body suspended via two torsion springs which can do tilting movements. The springs are each connected fixedly to the element frame at an anchor. Additionally, ribs are provided to limit the springs in their freedom of movement. When manufacturing the micromechanical elements, these are designed such that the resonant frequency, a priori, is higher than the desired set resonant frequency. Depending on the manufacturing variation or resonant frequency deviation, a different number of ribs are cut through to increase the freedom of movement and thus to decrease the spring stiffness of the springs and the resonant frequency and to bring the latter closer to the set resonant frequency. During operation, a virtual spring constant increase or decrease is obtained by applying a voltage difference between the vibrating body and suitably arranged stationary electrodes.

In one embodiment, the stationary electrodes are integrated into the element frame to generate a potential minimum in the rest position, which corresponds to a virtual spring constant increase. In another embodiment, the stationary electrodes are arranged above or below different sides of the pivot axis to generate a potential maximum in the rest position defined by the torsion springs, which is how a virtual spring constant decrease is achieved.

### BRIEF DESCRIPTION OF THE DRAWINGS

Preferred embodiments of the present invention will be detailed subsequently referring to the appended drawings, in which:

FIG. 1 is a spatial illustration of the vibrating system of a micromechanical element according to an embodiment of the present invention;

FIG. 2a shows a cross-section of a micromechanical element having the vibrating system of FIG. 1 through the line A-A and of an assembly of stationary electrodes according to an embodiment of the present invention;

FIG. 2b shows a cross-section of a micromechanical element having the vibrating system of FIG. 1 through the line A-A and of an assembly of stationary electrodes according to another embodiment of the present invention;

FIG. 3 is a spatial illustration of a vibrating system of a micromechanical element according to another embodiment of the present invention where the electrode assemblies of FIGS. 2a and 2b are possible;

FIG. 4 is a top view of a vibrating system of a micromechanical element according to another embodiment of the present invention where the electrode assemblies of FIGS. 2a and 2b are possible;

FIGS. 5a to 5c show a micromechanical element according to another embodiment where an electrode configuration is provided which is suitable for exciting a vibration, changing a virtual resonant frequency and for regulating the resonant frequency to an excitation frequency, FIGS. 5a and 5c showing top views and FIG. 5b showing a cross-sectional view along the line A-A of FIG. 5a and FIG. 5c additionally showing a regulating circuit for regulating resonance; and

FIGS. 6a to 6c are top views of vibrating systems having bending beams as an elastic suspension, in which the present invention may be implemented.

### DESCRIPTION OF THE PREFERRED EMBODIMENTS

Before the present invention will be explained subsequently in greater detail referring to the appended drawings, it is to be pointed out that the drawings are not to scale for better understanding. Additionally, same elements are provided with same reference numerals in the figures, a repeated description of these elements being omitted.

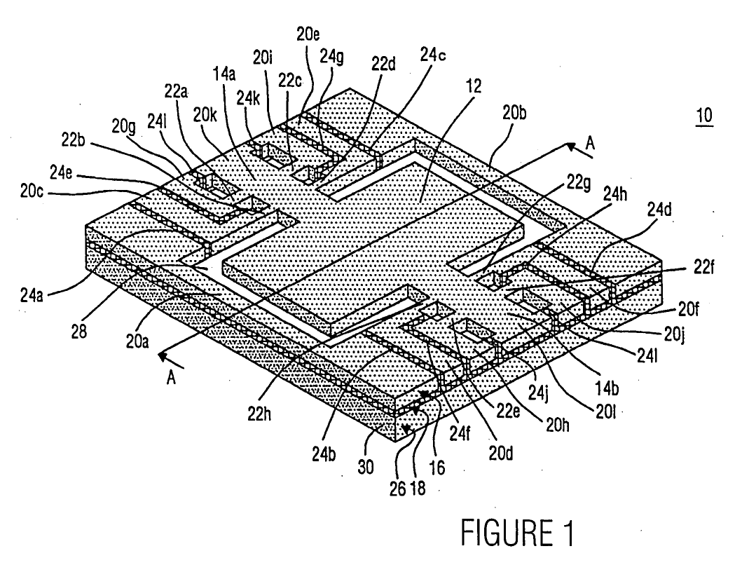

FIG. 1 shows an embodiment of a vibrating system of a micromechanical element, which is generally indicated by 10, where the present invention may be implemented, as will be explained subsequently. The micromechanical element 10 of the present embodiment represents a micromechanical mirror as is, for example, employed in micro-scanners to deflect a modulated light beam having a predetermined set frequency to move the light beam back and forth in an image field with the set frequency, whereby an image is generated on the image field by the modulated light spot moved on the image field. It is, however, pointed out that the present invention may obviously also be employed in other micromechanical elements having a vibrating system.

The micromechanical element. 10 includes a vibrating system including a vibrating body 12 serving as a mirror plate, and an elastic suspension 14 or 14a and 14b. Both the vibrating body 12 and the elastic suspension 14 are formed in a semiconductor layer 16. Below the semiconductor layer 16, which is, for example, made of highly-doped silicon, there is a buried insulation layer 18 which served as an etch stop when forming the vibrating body 12 and the suspension 14 in the layer 16. A frame 20 or 20a-20l and ribs 22 or 22a-22h are additionally formed in the layer 16. The element frame 20 consists of several sub-regions 20a-20l which are each separated from one another by insulation trenches 24a-24l and are made of an insulating material, such as, for example, silicon dioxide. The regions 20k and 20l serve as the so-called anchors for the suspension 14.

More precisely, the suspension 14 is made of two flat and elongated torsion springs 14a and 14b which are fixed at the anchor 20k or the anchor 20l at one end and at a middle of a- respectively opposite elongated side of the rectangular vibrating body 12 serving as a mirror at the other end. In addition to the mounting to the anchors 20k and 20l, the torsion springs 14a and 14b are fixed by the ribs 22a-22h at fixing points at the lateral circumference along their length between the anchors 20k and 20l and the vibrating body 12. More precisely, the ribs 22a-22h are based on predetermined fixing points along the lateral circumference of the torsion springs 14a and 14b, wherein the rib 22a ends at the frame region 20g of the element frame or is fixed there, the rib 22b ends at the region 20c or is fixed there, the rib 22c ends at the region 20i or is fixed there, the rib 22d ends at the region 22e or is fixed there, the rib 22e ends at the region 20h or is fixed there, the rib 22f ends at the region 20j or is fixed there, the rib 22g ends at the region 20f or is fixed there and the rib 22h ends at the region 20d 20 or is fixed there.

The ribs 22a-22h fix the torsion springs 14a, 14b each in pairs at respective opposite fixing points along the length of the torsion springs 14a, 14b. The fixing points of the ribs 22b, 22d or 22h and 22g are a little closer to the vibrating body 12, whereas the fixing points of the ribs 22a, 22c or 22f, 22e are a little closer to the anchor 20k, 20l.

When manufacturing the structures 12-24, i.e. the vibrating body 12, the suspension 14, the element frame 20, the ribs 22 and the insulation trenches 24, in the semiconductor layer 16, a suitable etching method has, for example, been employed where the buried insulation layer 18 served as an etch stop. This is why all the structures have the same thickness, namely the thickness of the semiconductor layer 16. The insulation trenches are filled with an insulating material so that the result is a continuous and stable element frame 20.

The vibrating body 12 serving as a mirror is formed as a rectangular plate. The torsion springs 14a, 14b, which are shaped in the form of elongated strips, are based on the middle of a respective side of the opposite elongated sides of the vibrating body 12 and end at the anchors 20k, 20l. In this way, the vibrating body 12 is allowed to pivot around a pivot axis through the torsion springs 14a, 14b. The torsion springs 14a, 14b here define a rest position where the vibrating body 12 is in the plane of the layer 16. When deflecting the vibrating body 12 from the rest position by tilting the vibrating body 12 around the pivot axis defined by the torsion springs 14, the torsion springs 14a, 14b cause a restoring force or torque back towards the rest position.

The entire construction is supported by a substrate 26 which is below the buried insulation layer 18 and is, for example, also formed of silicon. The substrate 26, the insulation layer 18 and the semiconductor layer 16 may, for example, be prepared as an SOI wafer (SOI=silicon on isolator) before manufacturing to form a plurality of micromechanical elements 10 there at the same time which are subsequently diced. In order to allow deflection of the vibrating body 12 from its rest position, the insulation layer 18 and the substrate 26 are removed below the vibrating body and the torsion springs 14a, 14b to form a cavity 28. The structures formed in the semiconductor layer 16 are thus only supported at the outer edge of the layer 16 by a substrate frame 30 onto which the layer 16 or the structures formed therein rest via the remainder of the buried insulation layer 18 not removed. The substrate 26 and the buried insulation layer 18 have been removed, except for the edge regions or the lateral edge of the layer 16, for producing the cavity 28, for example after structuring the semiconductor layer 16 by two suitable etching steps.

The vibrating body is thus not supported except for the torsion springs 14a, 14b. The torsion springs 14a, 14b are only fixed at the anchors 20k and 20l and the fixing points of the ribs 22a-22h. Due to the insulation trenches 24a-24l and the buried insulation layer 18, the individual regions of the element frame 20 formed in the layer 16 are electrically insulated from one another. The only electrical connection between the regions 20c, 20g, 20i and 20e to the anchor 20k and the regions 20d, 20h, 20j, 20f to the anchor 20l is via the ribs 22a-22h.

The micromechanical element 10 shown in FIG. 1 already provides adjustability of the resonant frequency of the vibrating system including the vibrating body 12 and the elastic suspension 14 in a discrete manner to compensate permanent resonant frequency deviations caused by manufacturing due to, for example, layer thickness variations of the layer 16 or the like already described in the introduction to the description from the set resonant frequency, this adjustability being explained subsequently in greater detail. Adjusting the resonant frequency is made possible via the spring stiffness of the spring-mass system or the vibrating system including the vibrating body 12 and the elastic suspension 14. The spring stiffness is changed by lengthening the effective, i.e. elastically deforming, spring length of the torsion springs 14a, 14b by releasing one or several solid body connections by the ribs 22a-22h between the torsion springs 14a, 14b and the element frame 20 starting from the ribs closer to the vibrating body 12, for example, directly after the setup of the micromechanical element 10 shown in FIG. 1 has been obtained. Each rib connection here can be selected separately for the release process.

The embodiment of the micromechanical element 10 shown in FIG. 1 has the particular characteristic, with regard to releasing solid body connections, that it may be performed easily. An embodiment for releasing the solid body connection and a discussion of the adjustability, made possible here, of the resonant frequency of the vibrating system in an irreversible and discrete way will be discussed below.

The individual regions 20a-20l of the element frame 20 are each provided with one contact (not shown) to render same electrically contactable, such as, for example, via wire bonding technology or the like. The semiconductor layer 16 is additionally manufactured to be conducting. For adjusting the resonant frequency towards a lower resonant frequency of the spring-mass system including the vibrating body 12 and the suspension 14, the ribs 22a-22h may be removed one after the other, wherein those ribs which are closest to the movable body 12 or the vibrating body 12, i.e. 22b, 22d, 22h, 22g are removed at first. This is how the effective length of the torsion springs 14a, 14b is increased and they comprise a lower stiffness, which is how in turn the resonant frequency of the vibrating system is decreased.

Every rib 22a-22h can be removed individually and independently of the others. Exemplarily, the separation process is illustrated with reference to the rib 22b. A voltage is applied between the region 20c which is limited by the insulation trenches 24a and 24e and the anchor region 20k. This voltage results in a current flow along an electrical path including a part of the torsion spring 14a and the rib 22c to be cut through. Since the rib 22c, compared to the spring 14a, has a smaller cross-section due to its dimensions and maybe a smaller specific conductivity due to its special, low doping and thus represents the greatest resistance along the electrical path between the anchor region 20k and the region 20c, the rib 22b heats up stronger than the spring 14a. With a suitably high voltage, the rib 22b is fused open, which results in a separation and consequently also in a decrease in the spring stiffness of the torsion spring 14a. The decrease in the spring stiffness 14a results from the fact that, when cutting through the rib 22c, the effective length of the torsion spring 14a available for torsion during vibration of the vibrating body 12 is increased. The same cut-through process may be performed at any other rib because every rib represents the greatest resistance along an electrical path between the anchor region 20k and one of the regions 20c, 20g, 20i, 20e or the anchor region 20l and one of the regions 20d, 20h, 20j and 20f.

For reasons of symmetry, it may also be practical to always cut through the ribs in double pairs, i.e. the four ribs having the same distance to the vibrating body 12, that is at first the ribs 22b, 22d, 22h, 22g closest to the vibrating body 12 and then ribs 22a, 22c, 22e and 22f.

As has become evident from the above discussion, the resonant frequency can only be adjusted towards lower frequencies by cutting through ribs. Additionally, the adjustment is irreversible. When manufacturing the micromechanical element 10, the fixing points should consequently be selected such that the resonant frequency of the vibrating body 12 in the state of non-cut-through ribs a priori is higher than the desired set resonant frequency.

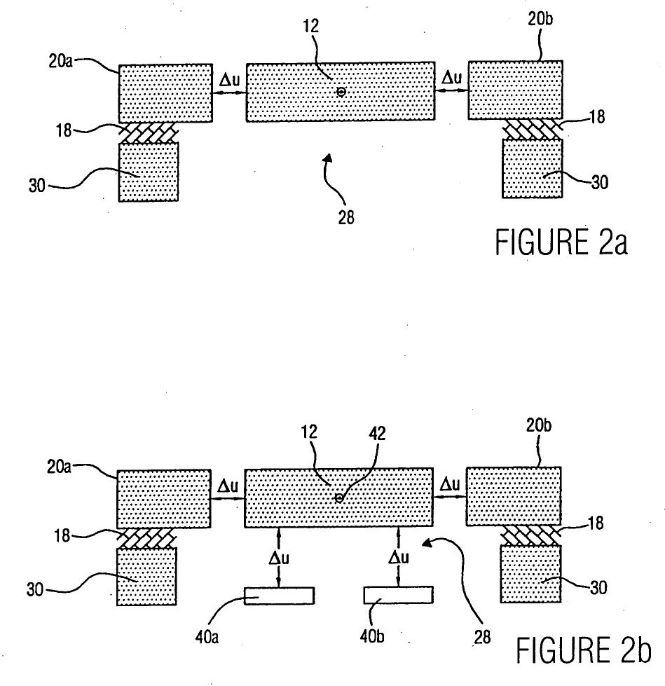

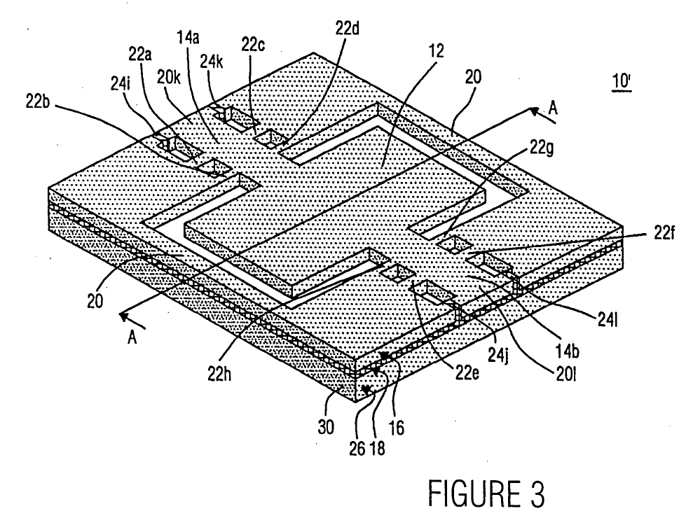

As has also become evident from the above discussion, the adjustability, which the micromechanical element 10 of FIG. 1 provides, of the resonant frequency is only possible in discrete steps and only with a constant effect for the remainder of the lifetime of the micromechanical element 10. Corrections or regulations of the resonant frequency for adjusting environmental variations and the effects thereof on the resonant frequency during operating time of the micromechanical element 10 are not possible. According to two embodiments which will be described subsequently referring to FIGS. 2a and 2b, the resonant frequency adjustability of the micromechanical element 10 described before by cutting through the ribs is supplemented by further adjustability which is also possible during operation. As will be discussed in detail below, an electrostatic method is used here where a constant voltage difference is applied between a part of the vibrating body serving as the moved electrode and a fixed electrode, which is how, depending on the electrode configuration or assembly, a force accelerating towards the rest position (FIG. 2a) or towards the turning point of the vibration (FIG. 2b) is caused when deflecting the vibrating body, which corresponds to an effective change of the spring stiffness of the torsion springs. This effective change of spring stiffness in turn causes a change of the resonant frequency of the vibrating system in dependence on the magnitude of the voltage difference applying, allowing regulating the resonant frequency or adjusting the resonant frequency in operation.

FIGS. 2a and 2b, each referring to an embodiment for an electrode configuration providing the additional adjustability just described, represent cross-sections of the micromechanical element 10 of FIG. 1 and of its vibrating system along the plane indicated in FIG. 1 by A-A. In both figures, FIGS. 2a and 2b, the vibrating body 12 is in its rest position.

Referring to FIG. 2a, a resonant frequency adjustment when operating the micromechanical element can be achieved by applying and varying a voltage between the vibrating body 12 on the one hand and a part of the element frame 20 on the other hand. As is shown in FIG. 2a, those regions of the element frame are used as a fixed counter-electrode to the vibrating body 12 representing the movable electrode, which are opposite to those parts of the vibrating body 12 which cover the greatest distance when deflecting the vibrating body 12 from the rest position, namely the regions 20a and 20b which are opposite the heads of the vibrating body 12.

When moving the vibrating body 12, the electrical force induced by the voltage difference AU between the vibrating body 12 on the one hand and the region 20a or 20b on the other hand or the electrical torque induced by the voltage difference always has an accelerating effect in the direction of the rest position of the spring-mass system. The rest position of the vibrating system, as is defined by the torsion springs 14a, 14b (FIG. 1), does not change by the voltage difference ΔU due to the symmetry of the assembly but matches or only differs slightly from the rest position defined by the voltage difference or the electrostatically caused forces.

The effect of the electrostatically caused torque may effectively be described by an increase in the spring constant of the vibrating system. To understand this, the dependence of the torque caused by the torsion springs 14a, 14b on a deflection a around the rest position with α=0 is, for example, considered. This dependence is linear with sufficiently small deflections. The gradient corresponds to the spring constant of the torsion springs. The electrostatic torque caused by the voltage difference is unidirectional to the torsion spring torque and also linear close to the rest position of α=0. Depending on deflection a, the overall torque has a greater gradient, which in turn corresponds to a virtual increase in the spring stiffness or spring constant of the torsion springs. Depending on the magnitude of the voltage difference ΔU applying, the resonant frequency may consequently be regulated to greater values since the resonant frequency in turn is a function of the effective spring constant.

Referring to the above description, it is pointed out that for generating the voltage difference ΔU either the regions 20a and 20b of the element frame 20 may be used as a fixed electrode to place them at a certain electrical potential or they may be provided with a metallic cover. The electrical potential of the vibrating body 12 can be defined via the electrical connection provided by the torsion springs. Instead, it is, however, also possible for the vibrating body to have a metallic cover as a movable electrode which may, for example, at the same time serve as a mirror cover and is made, for example, of Al.

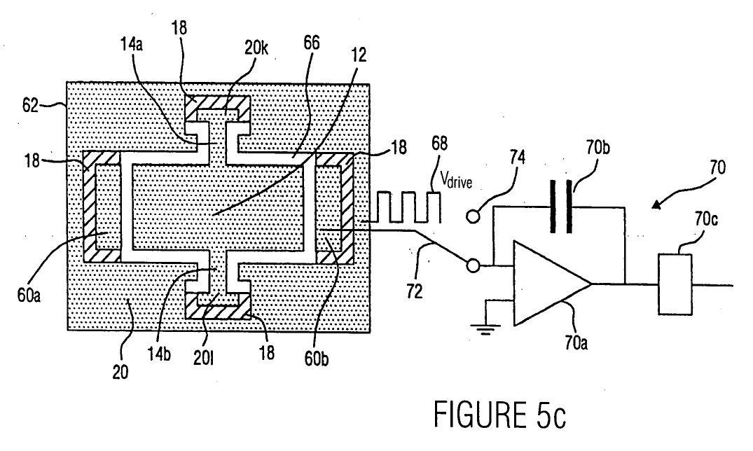

Continuing with the above description referring to FIG. 1 with regard to adjusting the resonant frequency of the vibrating system by irreversibly cutting through individual ribs, under the provision of the electrode configuration, as is shown in FIG. 2a, at the micromechanical element 10, the resonant frequency, as is defined by the vibrating system after cutting through the ribs, may be increased to a maximum value in a continuous manner by varying the voltage difference ΔU, the maximum value being defined by the maximum voltage difference. An example of how the resonant frequency of the vibrating system may be regulated to a certain set resonant frequency using the electrode configuration of FIG. 2a will be discussed subsequently referring to FIGS. 5a-5c.

FIG. 2b shows an embodiment of an electrode configuration for adjusting the resonant frequency of the vibrating system including a vibrating body 12 and an elastic suspension of the micromechanical element 10 of FIG. 1 during operation, where fixed electrodes below the vibrating body 12 are used as fixed electrodes 40a and 40b instead of using the regions 20a, 20b of the element frame in the layer 16. The counter-electrodes 40a and 40b are mounted at a fixed location and are opposite the vibrating body 12 across the cavity 28 in the same distance when the vibrating body 12 is in its rest position. More precisely, the counter-electrodes 40a and 40b are oriented in parallel to the rest position of the vibrating body 12 and arranged symmetrically to a plane through the rotational axis 42 and perpendicularly to the vibrating body 12 in its rest position. In this way, the counter-electrodes 40a and 40b are opposite to those parts of the vibrating body 12 which are subject to the greatest deflection from the rest position when the vibrating body 12 oscillates.

When there is an electrical voltage difference ΔU between the counter-electrodes 40a and 40b on the one hand and the movable body 12 on the other hand, the electrostatic force induced or the electrostatic torque induced causes a decrease in the spring constant of the spring-mass system. Consequently, the resonant frequency may be adjusted towards smaller resonant frequencies by the electrode configuration according to FIG. 2b. In order to understand this, it must be kept in mind that in the rest position, as is shown in FIG. 2b, there is no torque applied to the vibrating body 12 because for reasons of symmetry the electrostatic torque due to the voltage difference with regard to the counter-electrode 40a and the torque caused by the voltage difference with regard to the counter-electrode 40b are equal. When, however, the vibrating body 12 is, for example, deflected in a clockwise direction, as is seen in FIG. 2b, the distance between the counter-electrode 40b and the vibrating body 12 is smaller than that to the counter-electrode 40a, so that the attractive force caused by the counter-electrode 40b is greater than that caused by the counter-electrode 40a. Consequently, by the voltage difference ΔU, when deflecting the vibrating body 12 in the clockwise direction, a torque thereto is caused in the same direction. All in all, the electrode configuration of FIG. 2b consequently defines an energetic potential maximum in the rest position of the vibrating body 12, whereas the electrode configuration of FIG. 2a defines an energetic potential minimum in the rest position. Correspondingly, the electrode configuration according to FIG. 2b causes a smaller or greater virtual decrease of the spring constants of the vibrating system and thus also a decrease in the resonant frequency depending on the voltage difference between the vibrating body 12 on the one hand and the counter-electrodes 40a, 40b on the other hand. An example of regulating the resonant frequency of a vibrating system to a set resonant frequency by means of an electrode configuration according to FIG. 2b will be discussed below referring to FIGS. 5a-5c.

Implementing the electrode configuration of FIG. 2a may be realized by coating corresponding conductive electrodes on the element frame 20 and the vibrating body 12. The electrode configuration according to FIG. 2b, for example, only requires a metallic coating of the vibrating body 12 and providing the fixed electrodes below the vibrating body 12. In alternative embodiments, parts of a corresponding layer may also be used as electrodes instead of evaporations or covers, in case they are made of a conductive material.

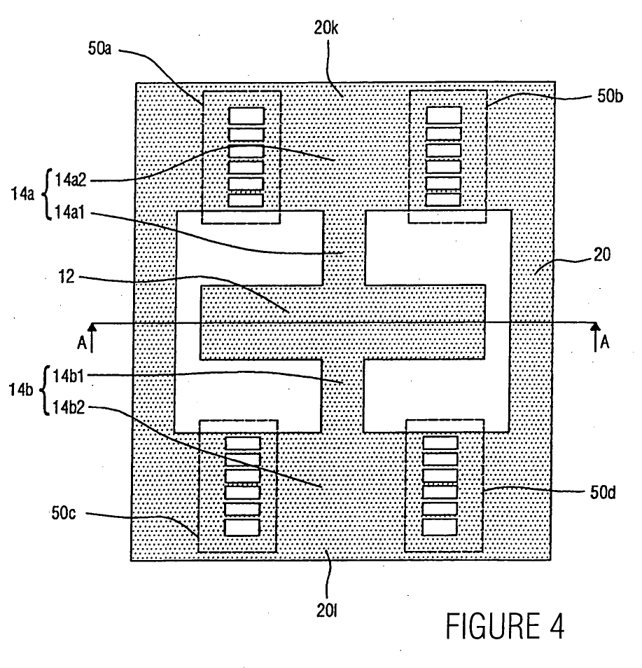

Referring to FIG. 3, another embodiment of a vibrating system of a micromechanical element which is structurally similar to that of FIG. 1 and in which the electrode configuration shown in FIGS. 2a and 2b may also be applied without problems will be described at first, which is the reason why the sectional plane A-A is also indicated in FIG. 3.

The micromechanical element of FIG. 3 which is generally indicated by 10′ only differs from that of FIG. 1 by the ribs 22a-22h not being electrically insulated from one another by insulation trenches. Expressed differently, only the insulation trenches 24i, 24j, 24k and 24l separating the anchor regions 20k and 20l from the remainder of the element frame 20 are provided below the insulation trenches of FIG. 1. The distance of the ribs and thus the adjustment of the resonant frequency in this embodiment may take place by a non-electrical method, i.e. not by fusing open, but, for example, by a laser beam evaporation or ion beam ablating method or by laser beam fusing. In contrast to the embodiment of FIG. 1, due to the different kind of cut-through method for the ribs 22a-22h no conductive material is required for the layer 16. Any other material may also be employed.

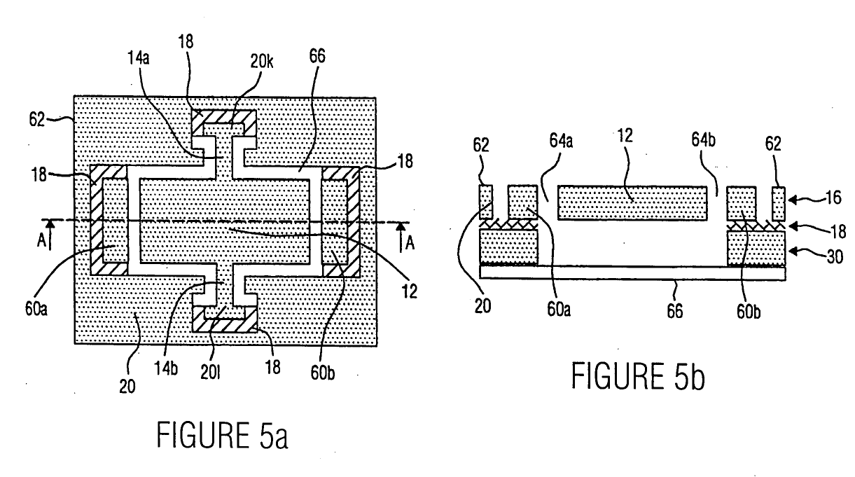

Another embodiment of a vibrating system of a micromechanical element where the electrode configuration of FIGS. 2a and 2b may be used for adjusting the resonant frequency of the vibrating system during operation, as is shown by the sectional place A-A, is shown in FIG. 4. The vibrating system of the micromechanical element according to FIG. 4 only differs from the embodiments according to FIGS. 1 and 3 by a special design of the torsion springs 14a and 14b. Insulation trenches like in FIGS. 1 or 3 are not illustrated in FIG. 4 for reasons of clarity but may be provided depending on the cut-through method to be used corresponding to the embodiments of FIG. 1 or FIG. 3.

Since the distances of the ribs are limited by the resolution of the structuring method used, the resolution of the adjustability is at first limited by the rib cut-through. A finer adjustment of the resonant frequency may be achieved when the torsion springs 14a and 14b are wider in the region of the ribs than in that region which is free for elastic deformations during deflection of the vibrating body 12 anyway, i.e. without cutting through any ribs. For finer adjustability, the torsion springs 14 and 14b of the micromechanical element of FIG. 4 are consequently made up of two parts, namely a lateral narrower spring part 14a1 or 14b1 and a lateral wider spring part 14a2 or 14b2. The spring parts 14a1 or 14b1 are arranged at the vibrating body 12 along the length of the torsion springs 14a and 14b, whereas the spring parts 14b2 and 14a2 are arranged at the side of the anchors 20k, 20l.

As can be seen, the portion of the lateral circumference of the torsion springs 14a and 14b where the ribs limit the torsion springs 14a and 14b in their freedom of movement is limited to the lateral wide spring parts 14a2 and 14b2, wherein these circumference or edge portions are indicated by broken lines 50a, 50b, 50c and 50d. Only the wide spring parts 14a2 and 14b2 are thus limited in their freedom of movement by the several ribs in the regions 50a-50d (presently six ribs each per region).

Due to the greater cross-section of the torsion springs 14a and 14b at the parts 14a2 and 14b2 compared to the narrower parts 14a1 and 14b1, the cut-through of the ribs one after the other from the vibrating body 12 causes a comparatively small increase in the freedom of movement or decrease in the spring stiffness of the torsion springs 14a and 14b compared to the case in which the torsion springs 14a and 14b are continually as narrow as the parts 14a1 and 14b1 because the part of the torsion springs added by this cut-through and taking part in the elastic deformation of the torsion springs 14a and 14b only contributes slightly to the elasticity of the spring. With regard to other characteristics, the micromechanical element of FIG. 4 corresponds to the embodiments of FIGS. 1 and 3.

A modification of the embodiment shown in FIG. 4 is to only form the wider part of the torsion springs at one side, i.e. only in one of the torsion springs, or to perform the widening at the sides of the vibrating body 12 to a differing extent. Thus, a coarser adjustment of the resonant frequency may be achieved by, for example, removing ribs on the one side, i.e. that with a smaller extent of widening and a finer adjustment of the resonant frequency may be achieved by removing ribs at the other side, i.e. that with a greater extent of widening. The distance and the width of the ribs may also differ.

Subsequently, an embodiment of a micromechanical element will be described referring to FIGS. 5a-5c, where an electrode configuration is provided which combines the two electrode configurations according to FIGS. 2a and 2b and is thus able to change the resonant frequency and which is additionally able to excite a vibration of the vibrating system and to detect the discrepancy between resonant frequency and excitation frequency and thus to regulate the resonant frequency to the excitation frequency so that the amplitude of the vibration of the vibrating system can be maximized.

Referring to FIGS. 5a and 5b, the setup of the micromechanical element will be described at first. FIG. 5a shows a top view of the micromechanical element, whereas FIG. 5b shows a cross-section along the broken like A-A of FIG. 5a. After that, the mode of functioning thereof as results from the regulating circuit shown there is described referring to FIG. 5c which also shows a top view of the micromechanical element.

With regard to the coarse mechanical setup, i.e. the limitation of the freedom of movement of the movable electrode to a pivoting movement, and with regard to the layer setup of a structuring layer 16, buried insulation layer 18 and substrate frame 30, the micromechanical element corresponds to the embodiment of FIG. 1. Regions 60a or 60b of the element frame 20 in the structuring layer 16 are electrically insulated from a remainder 62 of the element frame 20 and additionally also with regard to the suspension 14a, 14b and the vibrating body 12 which are all formed in one layer. The anchors 20k and 20l of the suspensions 14a and 14b are on the insulation layer 18.

The regions 60a and 60b serve as excitation electrodes, are electrically connected to each other so that they will always be at the same electrical potential, and are arranged opposite the ends of the vibrating body 12 facing away from the pivoting axis across a slot 64a and 64b, respectively. Expressed differently, the regions 60a and 60b are opposite the vibrating body 12 in its rest position in the same distance, at those respective positions which cover the greatest distances when the vibrating body 12 vibrates, i.e. those parts of the vibrating body 12 furthest away from the pivoting axis. The regions 60a and 60b will subsequently be referred to as external electrode.

The remainder 62 of the element frame 20 which is also insulated to the suspension 14 and the vibrating body 12 surrounds the vibrating body 12 along its circumference except for those positions where the vibrating body is suspended. In particular, the remainder 62 of the element frame 20 and the vibrating body are directly opposite to each other along the longitudinal portions of the vibrating body 12 across a slot and along the portions of the circumference furthest away from the pivoting axis, the excitation electrodes 60a and 60b being arranged therebetween. The remainder 62 of the element frame 20 serves as a counter-electrode in the sense of the embodiment of FIG. 2a and will subsequently be referred to as tuning electrode.

A conductive substrate plate 66 serving as a counter-electrode in the sense of the embodiment of FIG. 2b and being isolated from all other electrodes by the insulation layer 18 is arranged below the layer setup including the structuring layer 16 in which the vibrating body 12, the suspension 14 and the element frame 20 are formed, the buried insulation layer 18 and the substrate frame 30 of the vibrating body 12. The substrate plate 66 is arranged to be opposite the vibrating body 12 in parallel in a uniform distance in the rest position and will subsequently also be referred to as tuning electrode.

After the setup of the micromechanical element of FIGS. 5a-5c has been described herein before, the control and mode of functioning thereof will be described subsequently when it is, for example, used as a micro-scanner for deflecting a modulated light beam. The object of the micro-scanner is to produce a vibrating movement of the mirror 12 having a constant set frequency and the greatest possible amplitude to deflect a light beam with this frequency.

The excitation of the mirror 12 in this example takes place such that a periodic rectangular voltage is applied between the mirror 12 and the external electrode 60a and 60b, which changes between a first and a second voltage, as is indicated in FIG. 5c by 68 and as will be detailed below. Due to minimum asymmetries caused by manufacturing, a periodic deflection of the movable mirror 12 is obtained when applying a voltage having a suitable frequency. Because the capacity resulting between the mirror 12 and the external electrode 60a and 60b is maximal in the rest position of the mirror 12, an accelerating electrostatic torque results in the deflected state with a voltage applied. The maximum amplitude of the mirror vibration is obtained when the voltage is switched off precisely at the zero crossing of the vibration. Otherwise, either too little energy is coupled into the spring-mass vibrating system because the voltage is switched off before reaching the zero crossing, or energy is withdrawn by a braking electrostatic torque since the voltage is only switched off after passing the zero crossing. This fact is important for the procedure for regulating the vibrating amplitude described below.

Based on the considerations as they have been discussed referring to FIGS. 2a and 2b, variations of the resonant frequency can be compensated using the tune electrodes 62 or 66. A voltage of suitable quantity is applied between the tuning electrode 62 and the mirror 12 for increasing the resonant frequency or between the tuning electrode 66 and the mirror 12 to decrease the resonant frequency. This process is performed by a tuning electrode controller (not shown).

As has already been mentioned above, it is an object of a regulating circuit shown in FIG. 5c and described subsequently referring to this figure for the scanner mirror to be controlled such that a maximum vibrating amplitude of the mirror 12 is achieved by adjusting the resonant frequency by means of the tuning electrode controller with a fixed excitation frequency predetermined externally. In particular, the regulating circuit monitors the movement of the mirror 12 and, based on this monitoring, generates feedback control signals for the tuning electrode controller which responds to those control signals to change the resonant frequency of the vibrating system and thus the momentary vibrating amplitude.

An exemplary regulating circuit of this is generally indicated in FIG. 5c by 70. The regulating circuit 70 includes a charge amplifier for detecting the charge at the external electrode 60a and 60b, including a parallel circuit of an operational amplifier 70a and a capacity 70b and control means 70c. A first input of the amplifier is electrically connected to a first electrode of the capacity 70b and to the external electrode 60a and 60b via a switch 72. The output of the operational amplifier 70a is connected to the other electrode of the capacity 70b and to an input of the control means 70c. An output of the control means 70c forms the output for outputting the control signal of the regulating circuit 70 to the tuning electrode controller. Another input of the operational amplifier 70a is switched to ground.

The switch 72 is, as has been mentioned, connected between the regulating circuit 72 and the external electrode 60a and 60b with a first terminal. Another terminal of the switch 72 is connected to a voltage terminal 74 where there is the potential V_{drive}. The switch 72 provides for the drive of the mirror 12 described before by switching between the two terminals in an excitation frequency fixedly predetermined externally and thus generating an excitation voltage having a rectangular course and thus having the fixedly predetermined frequency between the mirror 12 which is also biased to the potential V_{drive} and the external electrodes 60a and 60b. Expressed in greater detail, the external electrode 60a and 60b, respectively, is switched between the operational amplifier 70a (virtual ground) and V_{drive} by the switch 72.

At the times when the switch 72 connects the regulating circuit 70 to the external electrode 60a and 60b, respectively, the charge on the external electrode 60a or 60b is determined by the regulating circuit 70. The temporal course of the charge on the external electrode 60a or 60b depends on the capacity between the mirror 12 on the one hand and the external electrode 60a and 60b on the other hand. While in the phase when the regulating circuit 70 is coupled to the external electrode 60a and 60b, the voltage V_{drive} accelerates the mirror 12 towards the rest position, the charge between the mirror 12 and the external electrode 60a and 60b can be determined by the circuit 70 by the operational amplifier 70a integrating, with the capacity 70b in the feedback loop, the current flowing to or from the electrode 60a or 60b from that point in time on when the switch 72 had last connected the input of the charge amplifier to the external electrode 60a or 60b, and transforming it to a voltage signal and outputting this result to the control means 70c. Expressed differently, the output signal of the operational amplifier 70a indicates the integration via the charge flow to the electrode 60a or 60b or away from it since the last switching of the switch 72, from which in particular the charge at the time of the last switching may be deduced.

When the voltage between the mirror 12 and the external electrode 60a or 60b is switched off by the switch 72 due to the externally predetermined frequency for the switch 72 before the mirror 12 has reached its rest position because the frequency of the mirror 12 is too low, the last value determined by the charge amplifier 70a, 70b is smaller than the actually maximum possible value of the charge. If the voltage is switched off due to the externally predetermined frequency after the mirror 12 has reached its rest position because the frequency thereof is too high, the last value of the charge determined is also smaller than the charge maximum obtainable, the charge maximum, however, has been passed and thus detected by the charge amplifier 70a, 70b and is in particular detectable by the control means 70c monitoring the output signal of the charge amplifier 70a, 70b.

In the first case where the control means 70c detects too low a mirror vibrating frequency, it must, by means of the control signals to the tuning electrode controller, provide for at least one potential of the two tuning electrodes 62 or 66 or the voltage between same and the mirror 12 to be changed such that the resonant frequency of the mirror 12 is increased virtually. In the second case, the control means 70c has to change at least one potential of the two tuning electrodes 62 or 66 such that the resonant frequency of the mirror 12 is decreased virtually, which is performed in the manner described referring to FIGS. 2a and 2b. When the tuning electrode 62 is at the potential V_{T1} and the tuning electrode 66 at the potential V_{T2}, a tuning voltage V_{T1}-V_{drive} between the mirror 12 and the electrode 62 and a tuning voltage V_{T2}-V_{drive} between the mirror 12 and the electrode 66 result. The purely mechanically determined resonant frequency results for the case V_{T2}=V_{T1}=V_{drive}. On the basis of this regulation by the control means 70c, the resonant frequency of the vibrating system is regulated to the excitation frequency of the switch 72 predetermined externally so that the vibrating amplitude is maximal with the excitation signal given due to the resonant increase. The vibrating amplitude may, in the regulated case, be varied via the magnitude of V_{drive}.

In summary, regulating of the vibrating amplitude takes place as follows according to the embodiment described above. With a fixed excitation frequency predetermined externally, the switch 72 provides for a vibration of the vibrating system by switching on and off an attractive voltage between the mirror 12 and the external electrode 60a or 60b, quasi in excitation phases with an attractive force and free-running phases without an attracting force. In order to maximize the vibrating amplitude of the vibrating system, the regulating circuit 70 regulates the resonant frequency of the vibrating system to the excitation frequency since the resonant increase is highest there. This takes place by the regulating circuit 70 monitoring the capacity or charge of the capacitor consisting of the mirror 12 on the one hand and the external electrode 60a or 60b on the other hand and determining from this whether the vibration of the vibrating system is leading or trailing with regard to the excitation frequency. In order for both frequencies to be equal, the capacity or charge between the mirror 12 and the electrode 60a or 60b must be greatest with a change from the free-running phase to the excitation phase and vice versa since in this case they would be closest to each other. A discrepancy of the two vibration frequencies results from a mismatching of the resonant frequency of the vibration frequency since the vibrating system changes towards the resonant frequency during the free-running phases, the resonant frequency being either smaller than or greater than the excitation frequency. The regulating circuit 70 then outputs the corresponding regulating signals to means which correspondingly change the tuning voltages between the mirror and the tuning electrode 66 on the one hand and between the mirror and the tuning electrode 62 on the other hand. These changes in turn change the resonant frequency, as has been described referring to FIGS. 2 and 2b, etc.

As an alternative to the previous embodiment of a regulation of the resonant frequency of the vibrating system, the excitation of the vibration could also take place via the electrodes 60a and 60b, respectively, and the determination of the charge via the electrode 62, the mirror 12 being switched to the potential V_{drive} and the electrode 60a or 60b being switched between ground and V_{drive}. In this case, the resonant frequency may also be adjusted by placing an offset or offset voltage onto the rectangular voltage between the mirror 12 and the external electrode 62, i.e. instead of switching the potential of the external electrode 60a or 60b between ground and V_{drive} and keeping the potential of the mirror at the potential V_{drive}, the electrode 60a or 60b is switched between a potential −Vₜᵤₙₑ and V_{drive}−Vₜᵤₙₑ so that the result is a rectangular voltage changing between V_{drive}+Vₜᵤₙₑ and V_{tune.} The offset also causes an additional constant electrostatic torque which increases the resonant frequency, corresponding to the embodiment of FIG. 2a. It may be required for maintaining the desired vibrating amplitude to adjust V_{drive} when Vₜᵤₙₑ changes.

Referring to the setup of the micromechanical element of FIGS. 5a-5c, it is pointed out that the tuning electrode 62 may be electrically insulated by an insulation trench from a chip edge of a chip in which the micromechanical element is integrated. In addition, the tuning electrode 66 may also be realized in a divided form so that two electrodes to the left and right of the torsion axis below the mirror would result. Furthermore, it is to be pointed out that the electrode regions, as has already been the case in the previous embodiments, may be formed either by conductive portions of the layer 16 which are separated by insulation trenches or by corresponding conductive cover regions.

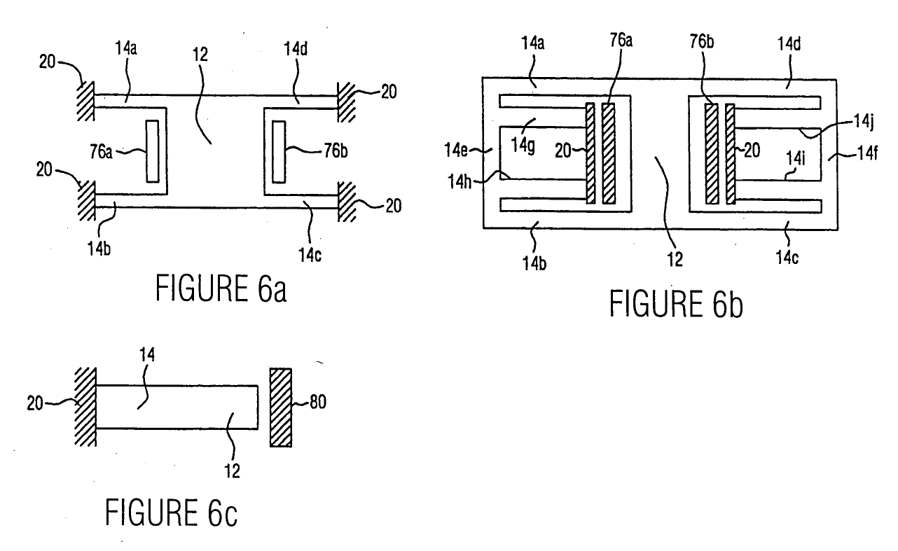

Referring to the previous description, it is to be pointed out that the above description was limited, only for better clarity, to embodiments where the vibrating body is suspended such that it could only perform tilting or a pivoting movement or pivoting vibration. The present invention, however, is applicable in any micromechanical element comprising a vibrating system including a vibrating body and an elastic suspension. FIGS. 6a-6c show further embodiments of such micromechanical elements.

FIG. 6a shows a vibrating body 12 which is suspended such that it may move back and forth in a translating manner with regard to the line of vision of FIG. 6a out of the image plane and into it. The suspension consists of elastic bending springs or bending beams 14a, 14b, 14c and 14d which extend in pairs in opposite directions based on the corners of the rectangularly formed vibrating body 12 to be fixed at anchor points of an element frame 20.

Like in the embodiments of FIGS. 1, 3, 4 and 5, with this embodiment, too, the vibrating body 12, the suspension 14 and the element 23 might be formed in one plane. Additionally, ribs which may be cut through can be provided which fix the bending beams 14a-14d having equal lengths at different fixing positions along their length to shorten their effective length and to increase the spring stiffness in the non-cut-through state and to increase the effective length and decrease the spring stiffness in the cut-through state.

Like in the embodiment of FIG. 2a, counter-electrodes 76a and 76b may be provided along the edge of the vibrating body 12 to virtually increase the spring constant of the spring-mass system by a voltage difference thereto. Like in the embodiment of FIG. 2b, counter-electrodes may be provided to virtually decrease the spring constant of the spring-mass system by a voltage difference thereto, such as, for example, a counter-electrode above and another counter-electrode below the vibrating body 12, both at the same electrical potential.

FIG. 6b shows a setup of a micromechanical element, the suspension of which also allows the vibrating body 12 to move back and forth in a translating manner. For a smaller lateral area consumption, the bending springs of the suspension, however, are not fixed externally at anchor points of an element frame, but are formed by several bending spring segments which together shape a U form. First bending spring segments 14a extend from the corners of the vibrating body 12 each in pairs in opposite directions to a non-supported cross-bending beam 14e and 14f, respectively. From these cross-bending beams 14e or 14f, bending springs 14g, 14h and 14i and 14j, respectively, which are positioned closer towards the center, each extend towards the center in the direction of the vibrating body 12 to be fixed at anchor points 20. Again exemplarily, counter-electrodes 76a and 76b opposite the vibrating body 12 along the circumference are shown, which may serve as counter-electrodes of the type according to FIG. 2a. Counter-electrodes according to FIG. 2b may be provided above and below the vibrating body 12. The length of the bending spring is increased compared to the setup of FIG. 6a by the length of the bending springs 14g, 14h, 14i and 14j.

In FIG. 6c, a micromechanical element where the vibrating body 12 and the suspension 14 are not only formed integrally but also flow into one another without transition as a cantilevered beam which is fixed to an anchor 20. Exemplarily, opposite the free end of the cantilever corresponding to the vibrating body 12, a counter-electrode 80 which might serve the same function as the counter-electrodes according to the embodiment of FIG. 2a is arranged. Counter-electrodes according to FIG. 2b might be provided above and below the vibrating body 12.

It is to be pointed out that, although only embodiments have been described before referring to FIGS. 1-5 which allow both discrete adjustability of the resonant frequency of the vibrating system by irreversibly cutting through ribs and adjustability by defining an electrostatic energy minimum or energy maximum in the rest position of the vibrating body, the present invention is not limited to these embodiments. The adjustability of the resonant frequency by cutting through ribs may be omitted. Nevertheless, the combination of these two ways of adjusting yields an important advantage because, by the pre-adjustability provided by cutting through ribs, also those micromechanical elements may be utilized which, directly after manufacturing, have a resonant frequency which is outside the frequency regulation range provided by the inventive principle of electrostatic adjustability. This is of particular advantage because generally the regulation range of the resonant frequency by the electrostatic definition of a potential minimum or maximum is small compared to the manufacturing variations so that a large number of elements manufactured having too great a resonant frequency deviation could not contribute to the yield without the adjustability by cutting through ribs. This combined way of adjusting and regulating consequently is able to compensate both deviations and variations of the resonant frequency, which is how the yield in manufacturing is increased significantly. Additionally, one and the same element may be used for related applications when the applications only differ by the resonant frequency desired because these elements only differ by the different number of ribs cut through. Consequently, these micromechanical elements may, except for cutting through ribs, be manufactured in the same manner and thus cheaply.

Removing the ribs may not only, as has been described before, take place through a current flow, ion beams or laser beams, but also through electron beams or electromagnetic radiation. Furthermore, the vibrating body may also be suspended non-symmetrically, different from what is shown in FIGS. 1, 3, 4, 5, 6a and 6b. In general, the vibrating body may be suspended such that tilting, translation, rotation or any complex movement combined from rotation, translation and tilting in any direction and manner, may be performed. Instead of arranging the counter-electrodes, according to the embodiment of FIG. 2b, below the vibrating body, they may of course also be arranged above.

In addition, it is to be pointed out that when using two independent voltage sources, also an electrostatic repulsion between a fixed counter-electrode on the one hand and a vibrating body on the other hand could be achieved by applying like charges to the vibrating body on the one hand and the fixed electrode on the other hand so that in the embodiments of FIGS. 2a and 2b described above, opposite effects could be achieved, i.e. a spring constant reduction instead of a virtual spring constant increase and vice versa, which is, however, less preferred due to the technological complexity.

Referring to the embodiment of FIG. 1, it is pointed out that the insulation trenches need not be closed but may also be open. In addition, the structures formed in the semiconductor layer, such as, for example, spring, vibrating body and frame, may not only comprise same thicknesses, but may also comprise different thicknesses, such as, for example, by means of a suitable etching method for thinning special positions.

Additionally, it is pointed out that, although previously referring to FIG. 5 only an excitation system operating according to the electrostatic principle for exciting the vibration of the vibrating system has been described, magnetic forces, piezoelectric forces or sound could also be used for exciting the vibration.

Also, it is pointed out that, although previously reference has only been made to a micro-mirror as a potential application of the present invention, the present invention can also be employed in other micromechanical elements having an adjustable vibrating frequency, and in particular in sensors. The invention is of particular advantage in applications where the vibrating system of a micromechanical element is operated in its resonant frequency or close to its resonant frequency so that the increase in the vibrating amplitude is utilized by the resonance effect.

With regard to the embodiment of FIGS. 2a and 2b, it is pointed out that only one counter-electrode is required. In the case of FIG. 2b, the two counter-electrodes 40a and 40b may be replaced by a common one extending over both.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A micromechanical element comprising:
a vibrating system comprising:
a vibrating body; and
an elastic suspension by means of which the vibrating body is suspended to be able to vibrate; and
an adjuster for adjusting a resonant frequency of the vibrating system by applying a voltage difference between at least one part of the vibrating body and at least one stationary electrode.

2. The micromechanical element according to claim 1, wherein the stationary electrode is arranged such that it causes an electrostatic counter-force in a direction of the rest position when the vibrating body is deflected from its rest position.

3. The micromechanical element according to claim 1, wherein the stationary electrode is arranged such that it causes an electrostatic force in a direction away from the rest position when the vibrating body is deflected from its rest position.

4. The micromechanical element according to claim 1, comprising a static electrode of a first kind and a static electrode of a second kind, wherein the static electrode of the first kind is arranged such that it causes an electrostatic counter-force in the direction of the rest position when the vibrating body is deflected from its rest position, and the static electrode of the second kind is arranged such that it causes an electrostatic force in the direction away from the rest position when the vibrating body is deflected from its rest position.

5. The micromechanical element according to claim 1, further comprising:
a rib which may be cut through for optionally fixing the elastic suspension at a fixing point to limit a deformation range of the elastic suspension in which the elastic suspension deforms elastically when the vibrating body vibrates in a non-cut-through state and to increase same in a cut-through state.

6. The micromechanical element according to claim 5, comprising several ribs which may be cut through for fixing the elastic suspension at a respective fixing point in a non-cut-through state.

7. The micromechanical element according to claim 5, wherein the elastic suspension comprises a first part having a smaller cross-section and a second part having a greater cross-section.

8. The micromechanical element according to claim 1, wherein the vibrating body, the elastic suspension and the stationary electrode are formed in one layer.

9. The micromechanical element according to claim 8, wherein a frame having an anchor where the elastic suspension is fixed and a rib extending between a fixing point of the elastic suspension and the frame and being either cut through or not cut through are additionally formed in the layer.

10. The micromechanical element according to claim 8, wherein the static electrode is opposite to that part of the circumference of the vibrating body across a slot in the layer which is subject to the greatest deflection when the vibrating system vibrates.

11. The micromechanical element according to claim 1 having a first stationary electrode which is arranged such that it approaches the at least one part of the vibrating body with a deflection of the vibrating body from its rest position in a first deflection direction, and withdraws from the at least one part of the vibrating body with a deflection of the vibrating body from its rest position in a second deflection direction, and a second static electrode which is arranged such that it withdraws from the at least one part of the vibrating body with a deflection of the vibrating body from the rest position in the first deflection direction, and approaches the at least one part of the vibrating body with a deflection of the vibrating body from the rest position in the second deflection direction.

12. The micromechanical element according to claim 1, wherein a first torsion spring, a second torsion spring and the vibrating body are formed in one layer, wherein the first and the second torsion springs define a pivot axis for the vibrating body which divides the vibrating body into a first and a second part which move in different directions from the layer plane of the layer with a deflection of the vibrating body from its rest position, wherein a first and the second static electrode are arranged either below or above the vibrating body and the first static electrode is opposite to one of the two parts of the vibrating body and the second static electrode is opposite to the other one of the two parts.

13. The micromechanical element according to claim 1, wherein the elastic suspension has the effect of a torsion spring.

14. The micromechanical element according to claim 1, wherein the elastic suspension has the effect of a cantilevered bending spring.

15. The micromechanical element according to claim 1, wherein the elastic suspension is arranged to limit a vibrating movement of the vibrating body to a tilting movement around a pivot axis.

16. The micromechanical element according to claim 1, wherein the elastic suspension is arranged to limit a vibrating movement of the vibrating body to a translatory movement along a pivot axis.

17. A method for operating a micromechanical element having a vibrating system comprising a vibrating body and an elastic suspension by means of which the vibrating body is suspended to be able to vibrate, the method including the step of:
adjusting a resonant frequency of the vibrating system by applying a voltage difference between at least one part of the vibrating body and at least one stationary electrode.
